(19) United States
(12) Patent Application Publication
(10) Pub. No.: US 2026/0231919 A1
(43) Pub. Date: Aug. 13, 2026

(54) FISH BAIT RETAINING LURE

(71) Applicant: B. S. Fish Tales, Inc., Vancouver, WA (US)

(72) Inventors: Scott Kaul, Puyallup, WA (US); Jared Berg, Bellingham, WA (US)

(73) Assignee: B. S. Fish Tales, Inc., Vancouver, WA (US)

(21) Appl. No.: 19/533,848

(22) Filed: Feb. 9, 2026

Related U.S. Application Data
(60) Provisional application No. 63/757,239, filed on Feb. 11, 2025.

(51) Int. Cl. A01K 85/00; A01K 85/01; A01K 85/02

(52) U.S. Cl. CPC A01K 85/1847; A01K 85/018; A01K 85/019; A01K 85/02

(57) ABSTRACT

A fish bait retaining lure that has a belly portion and a body portion. The body portion has a nose portion, a midsection portion that is flexible, wherein a flexibility of the midsection portion corresponds to a predefined flexibility coefficient, and a tail portion. The body portion and the belly portion cooperatively define a bait retaining cavity in the fish bait retaining lure that is configured to releasably hold a bait material of interest

### CROSS REFERENCE TO RELATED APPLICATION

This non-provisional application claims the benefit of co-pending provisional application Ser. No. 63/757,239, filed Feb. 11, 2025, titled Fish Bait Retaining Lure, the entirety of which is hereby incorporated herein by reference.

### FIELD OF THE INVENTION

The invention relates generally to sport fishing and, more particularly, to a fish bait retaining lure used for sport fishing.

### BACKGROUND OF THE INVENTION

Legacy fish bait retaining lures are configured to retain a fish bait that creates a scent that is intended to attract a fish towards the fish bait retaining lure as scent leaches out from the bait into the surrounding water. Some types of fish bait retaining lures include an interior cavity that is configured to hold and retain the fish bait during use. However, these legacy fish bait retaining lures have various deficiencies.

For example, securing the fish bait retaining lure after fish bait has been placed into the interior cavity may be difficult. One legacy fish bait retaining lure employes one or more rubber bands or elastic bands to retain the bait cavity in a closed position. Placing the rubber or elastic band in place may be difficult in view of a fishing line that may be attached to the fish bait retaining lure. Also, hooks secured to the outside of the fish bait retaining lure may interfere with proper placement of the rubber or elastic band. Further, a rubber or elastic band may be subject to failure (breakage), especially after many uses. And, if the weather is inclement and/or is cold, the user's fingers may have difficulty manipulating the rubber or elastic band when securing the cover of the fish bait retaining lure.

For these reasons, there is a need for an improved fish bait retaining lure.

### SUMMARY OF THE INVENTION

It is therefore an object of the present invention to provide an improved fish bait retaining lure that is easier to use. An example embodiment comprises a belly portion and a body portion. The body portion comprises a nose portion, a midsection portion that is flexible or semiflexible, and a tail portion. The body portion and the belly portion cooperatively define a cavity in the fish bait retaining lure that is configured to releasably hold bait or other material of interest

### BRIEF DESCRIPTION OF THE DRAWINGS

Preferred and alternative embodiments of the present invention are described in detail below with reference to the following drawings.

FIG. 1 is a top perspective view of an example fish bait retaining lure.

FIG. 2 further illustrates an example rigging of the fish bait retaining lure with two hooks and a plurality of colored beads.

FIG. 3 is an exploded side view of the fish bait retaining lure.

FIG. 4 shows a closed fish bait retaining lure being held by the user's fingers prior to opening to access the cavity.

FIG. 5 illustrates the opened fish bait retaining lure.

FIG. 6 illustrates a hinge cavity of the hinge disposed in the nose portion of the body portion.

FIG. 7 illustrates a hinge tab of the hinge disposed on the proximal end of the belly portion.

FIG. 8 is an exploded side view of the locking tab system.

FIG. 9 is an exploded top view of the locking tab system.

FIG. 10 is a side perspective view of the hook garage disposed near the proximal end of the belly portion.

FIG. 11 is a bottom view of the proximal end of the belly portion showing the interior passage of the hook garage.

FIG. 12 is a frontal view of the nose portion of the body portion.

FIG. 13 is a bottom view of the nose portion.

FIG. 14 is a view of the cavity of the body portion and the cavity of the belly portion.

### DETAILED DESCRIPTION OF THE PREFERRED EMBODIMENT

A fish bait retaining lure 100 in accordance with the principles of the invention is generally indicated in the Figures of the attached drawings, wherein numbered elements in the Figures correspond to like numbered elements herein.

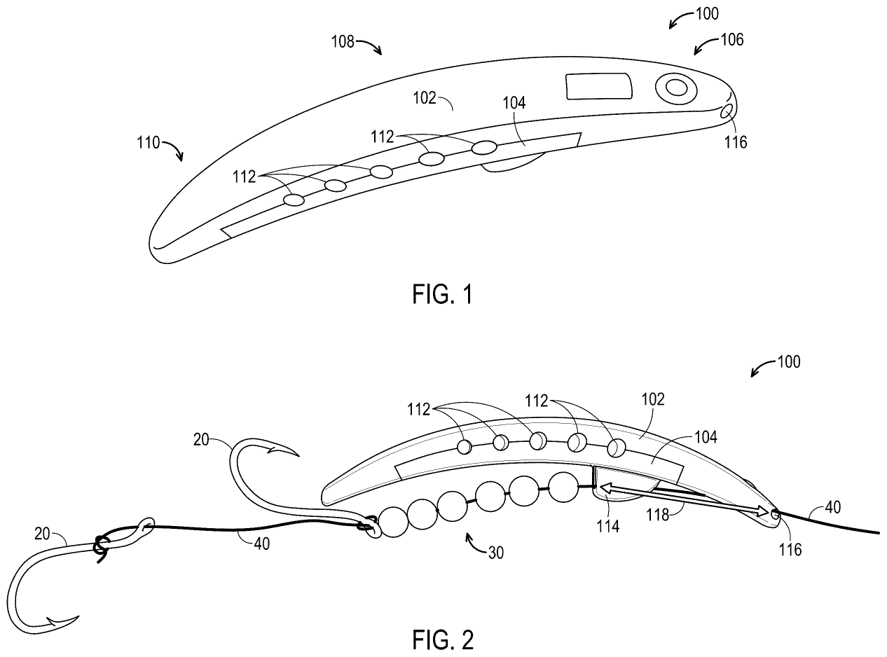

FIG. 1 is a top perspective view of an example fish bait retaining lure 100. FIG. 2 is a side view of the fish bait retaining lure 100 of FIG. 1. The fish bait retaining lure 100 comprises a body portion 102 and a belly portion 104. The body portion 102 is defined by a nose portion 106, a midsection portion 108, and a tail portion 110.

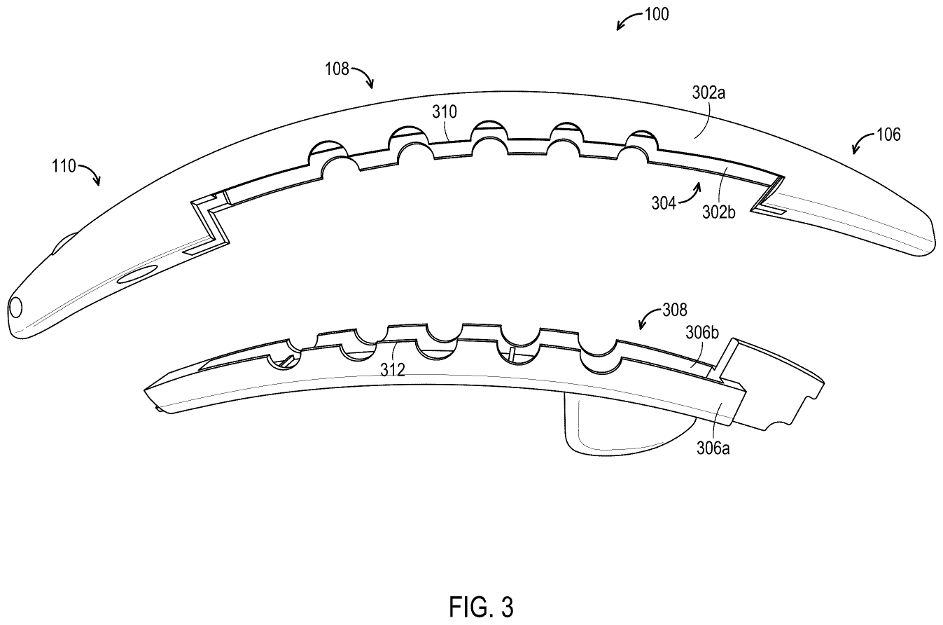

When assembled, the body portion 102 and the belly portion 104 cooperatively define a bait retaining cavity 304, 308 (FIG. 3) within the interior of the fish bait retaining lure 100. The bait retaining cavity 304, 308 is configured to retain fish bait and/or other material of interest during use.

A plurality of apertures 112 are cooperatively defined by the joined surfaces of the body portion 102 and the belly portion 104. Other example embodiments includes five apertures 112 on each side of the fish bait retaining lure 100. Any suitable number of apertures 112 on the sides of the fish bait retaining lure 100 may be used in alternative embodiments. The number of apertures 112 may be different on each side, a diameter of each aperture 112 may be the same or different, and/or any suitable spacing between apertures 112 may be used in the various embodiments. Any suitable shape may be used for the apertures 112, including ellipses, squares, rectangles, etc. In some embodiments, the apertures may be optionally or alternatively disposed on the sides, top, and/or bottom of the body portion 102 and/or the belly portion 104.

FIG. 2 further illustrates an example rigging of the fish bait retaining lure 100 with two hooks 20 and a plurality of colored beads 30 (which are not considered elements of the present invention, though they may be optionally included in the same packaging as the fish bait retaining lure 100). Any number of hooks 20 and beads 30 may be used to rig the fish bait retaining lure 100 for fishing. One or more of the beads 30 may be replaced with other structure, such as, but not limited to, tubing, or other spacing means that retain the one or more hooks 20 in a desired location with respect to the fish bait retaining lure 100. A fishing line 40 secures the hooks 20 and beads 30 at the distal end of the fishing line 40. The fishing line 40 extends through an optional hook garage 114 of the belly portion 104 and through a fishing line tunnel 116 that extends through the nose portion 106 of the body portion 102.

During use, the curvature of the fish bait retaining lure 100 is configured to spin about the fishing line 40. The spin of the fish bait retaining lure 100 is about a lateral axis 118 between the aperture of the hook garage 114 and the fishing line tunnel 116. Water is urged through the apertures 112 and the hook garage 114 as the fish bait retaining lure 100 spins about the axis 118. Scent contained in the bait slowly leaches out of the bait, and is then transported out of internal bait retaining cavity 304, 308 into the surrounding water. In some applications, additional scent may be applied to the bait. Alternatively, or additionally, scent may be applied to a sponge that is inserted into the bait retaining cavity 304, 308 of the fish bait retaining lure 100. The sponge, which may be formed to fit the interior of the bait retaining cavity 304, 308 of the fish bait retaining lure 100, dispenses the scent during use. The scent is intended to attract game fish towards the fish bait retaining lure 100. Hopefully, the approaching fish strikes (bites) at the fish bait retaining lure 100 and becomes hooked on the trailing hooks 20.

As used herein, the following terms take the meanings explicitly associated herein, unless the context clearly dictates otherwise. The terms “front,” “forward,” “rear,” and “rearward” are defined relative to nose portion 106 of the belly portion 104. The term “lateral” is defined relative to the lateral axis 118 of the defined by the hook garage 114 of the belly portion 104 and the fishing line tunnel 116 of the body portion 102. One skilled in the are appreciates that with respect to fish, the lateral line is a sensory system that helps fish detect water pressure and movement. A fish's lateral line may be visible as faint lines of pores running along each side of a fish's body from proximate to the head of the fish to proximate the tail of the fish.

The term “configured” as used herein means an element being one or more of sized, dimensioned, positioned, or oriented to achieve or provide the recited function or result. The term “directly coupled” as used herein means that a component contacts (for example, when bolted) or is welded to another component. The term “indirectly coupled” as used herein means that a first component is coupled to a second component by way of one or more intervening components that are directly coupled to the first and second components. A first component that is indirectly coupled to a second component is directly coupled to a third component, which may be directly coupled to the second component or to a fourth component that is directly coupled to the second component. The term “coupled” should therefore be understood to disclose both direct and indirect coupling of components or elements that are described as being coupled to each other.

The term “or” is an inclusive grammatical conjunction to indicate that one or more of the connected terms may be employed. For example, the phrase “one or more A, B, or C” or the phrase “one or more As, Bs, or Cs” is employed to discretely disclose each of the following: i) one or more As, ii) one or more Bs, iii) one or more Cs, iv) one or more As and one or more Bs, v) one or more As and one or more Cs, vi) one or more Bs and one or more Cs, and vii) one or more As, one or more Bs, and one or more Cs. The term “based on” as used herein is not exclusive and allows for being based on additional factors not described. The articles “a,” “an,” and “the” include plural references. Plural references are intended to also disclose the singular.

FIG. 3 is an exploded side view of the fish bait retaining lure 100. The opposing side walls 302a and 302b of the midsection portion 108 cooperatively define a cavity 304, interchangeably referred to herein as a body portion cavity 304, disposed in the body portion 102. Similarly, opposing side walls 306a and 306b of the belly portion 104 define a cavity 308, interchangeably referred to herein as a belly portion cavity 308. In other embodiments, only one of the cavities 306a or 306b are included in the fish bait retaining lure 100.

In the preferred embodiment, when the belly portion 104 is secured to the body portion 102, the edge surface 310 of the side walls 302a and 302b and the edge surface 312 of the side walls 306a and 306b tightly engage each other to form a larger bait retaining cavity within the fish bait retaining lure 100. In practice, a user may separate the body portion 102 and the belly portion 104, insert a suitable bait or other material of interest into the cavity 304 and/or 308, and then close up the fish bait retaining lure 100 so that the engaged body portion 102 and belly portion 104 secure and retain the inserted bait or other material within the bait retaining cavity of the fish bait retaining lure 100.

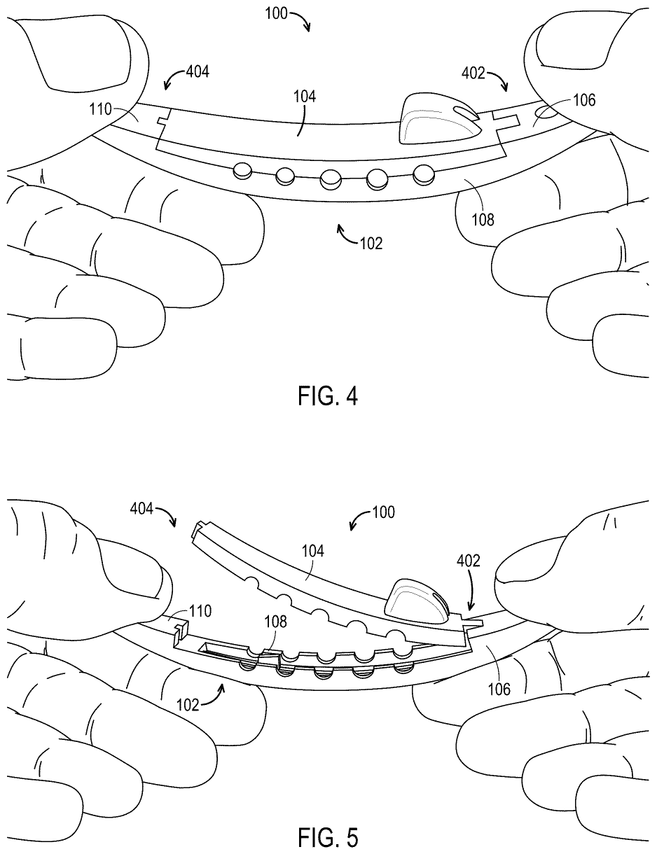

FIG. 4 shows a closed fish bait retaining lure 100 being held by the user's fingers prior to opening the fish bait retaining lure 100 to access the cavity. Here, the body portion 102 and the belly portion 104 are tightly engaged and held together.

In a preferred embodiment, the nose portion 106 and the tail portion 110 of the body portion 102 are made of a rigid or semi-rigid material. The midsection portion 108 is made of a flexible or semi-flexible material. The nose portion 106, the midsection portion 108, and the tail portion 110 preferably form a unibody fish bait retaining lure 100. The belly portion 104 is preferably made of a rigid or semi-rigid material. However, other embodiments may use flexible or semi-flexible materials for all of, or selected portions of, the body portion 102 and/or the belly portion 104. Flexibility of the midsection portion 108 may be predefined in accordance with a selected flexibility coefficient (which corresponds to the displacement of the midsection portion 108 under a unit of applied force).

The distal end of the nose portion 106 and the proximal end of the belly portion 104 are joined together using a suitable hinge system 402. Preferably, the hinge system 402 is a cam type hinge (interchangeably referred to herein as a cam hinge 402) that is separable so that the belly portion 104 may be removed from the body portion 102 for cleaning. The ability to thoroughly clean the interior of the cavity and the separated hinge system 402 is a unique feature of the fish bait retaining lure 100. Optionally, the separated belly portion 104 may be replaced with other like belly portions 104 that have alternative colors and/or alternative patterns.

In preferred embodiments, the edge surface 310 of body portion 102 and/or the edge surface 312 of the belly portion 104 tightly engage each other to form a larger cavity within the fish bait retaining lure 100. Preferably, the edge surfaces 310, 312 are substantially aligned with the lateral line of a bait fish that is being emulated by the fish bait retaining lure 100. This feature has been discovered to provide an improved effectiveness in attracting game fish. Coloration and/or texture of the surface proximate the edge surfaces 310, 312 may be included on the surface of the fish bait retaining lure 100 to emulate a real lateral line of a bait fish.

An unexpected benefit to the user of being able to switch out belly portions 104 that have alternative colors and/or alternative patterns is that each belly portion 104 and body portion 102 may have the same or substantially the same emulated lateral line of the bait fish, thereby allowing each combination of a belly portion 104 with a body portion 102 to appear more realistic since the lateral line of the bait fish is emulated regardless of which particular belly portion 104 or body portion 102 is used in the fish bait retaining lure 100.

The proximal end of the tail portion 110 and the distal end of the belly portion 104 are secured together using a suitable locking system 404. When closed, the locking system 404 is engaged so that the hinge system 402 and the locking system 404 cooperatively secure the belly portion 104 to the body portion 102.

To open the fish bait retaining lure 100 (to disengage the belly portion 104 from the body portion 102), the user flexes the body portion 102 by exerting a downward force concurrently on the nose portion 106 and the tail portion 110. Optionally, the user may concurrently exert an upward force on the opposing surface of the belly portion 104. This flexing causes a separation between the proximal end of the tail portion 110 and the distal end of the belly portion 104 such that the locking system 404 releases. The distal end of the belly portion 104 then springs outwardly and away from the proximal end of the tail portion 110, as illustrated in FIG. 5. In a preferred embodiment, the hinge system 402 remains coupled so that the belly portion 104 does not immediately separate from the body portion 102.

To close the fish bait retaining lure 100, the user couples the belly portion 104 and the body portion 102 by re-engaging the hinge system 402. Then, the user presses the distal end of the belly portion 104 towards the proximal end of the tail portion 110 and/or flexes the belly portion 104. By exerting a force onto the tail portion 110 and/or flexing the belly portion 104, the locking system 404 engages and then secures the belly portion 104 and the body portion 102 together to close the fish bait retaining lure 100.

FIG. 5 illustrates the opened fish bait retaining lure 100. The user has access to the cavity of the fish bait retaining lure 100. The user can add new fish bait or other material of interest, clean out previously inserted fish bait or other material of interest, and/or clean the cavity. Since the hinge system 402 is preferably separable, the user may remove the belly portion 104 from the body portion 102. Further, the user may then couple a different belly portion 104 (with a different color and/or pattern) to the body portion 102.

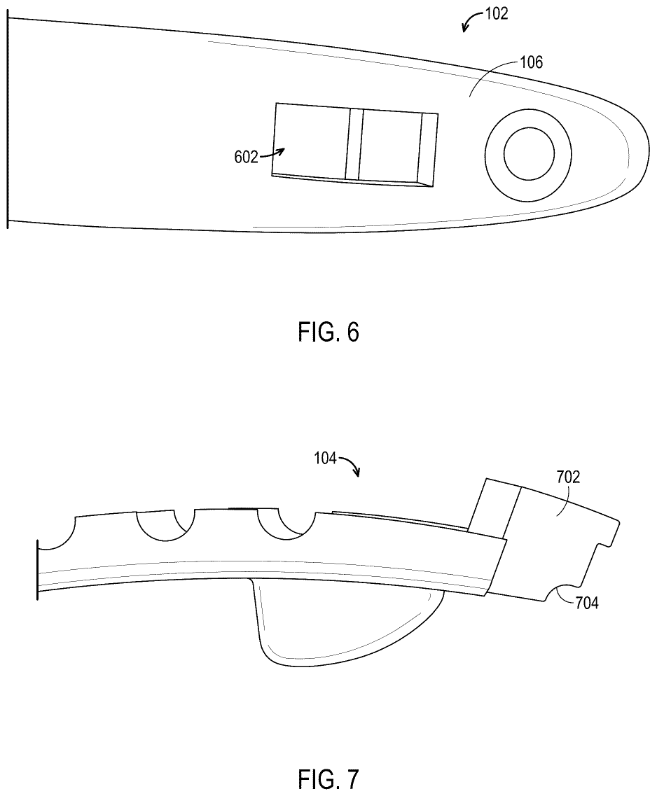

FIG. 6 illustrates a hinge cavity 602 of the hinge 402 disposed at the distal end of the nose portion 106 of the body portion 102. FIG. 7 illustrates a hinge tab 702 of the hinge system 402 disposed on the proximal end of the belly portion 104. The hinge tab 702 is configured to be inserted into the hinge cavity 602. When the belly portion 104 is engaged with the body portion 102, a rotation surface 704 of the hinge tab 702 engages a corresponding curved surface portion of the hinge cavity 602. This rotation surface 704 allows a rotation of the belly portion 104 so as to secure the proximal end of the belly portion 104 with the distal end of the nose portion 106. The belly portion 104 is disengaged from the body portion 102 by rotating the distal end of the belly portion 104 outwardly and away from the proximal end of the tail portion 110, as illustrated in FIG. 5. Then, the hinge tab 702 may be pulled out of the hinge cavity 602 so that the belly portion 104 can be separated from the body portion 102.

Alternative embodiments of the fish bait retaining lure 100 may use alternative types of hinge systems 402. In some alternative embodiments, the hinge system 402 may not be separable such that the belly portion 104 cannot be separated from the body portion 102. All such alternative embodiments are intended to be included within this disclosure of the invention and to be protected by any accompanying claims.

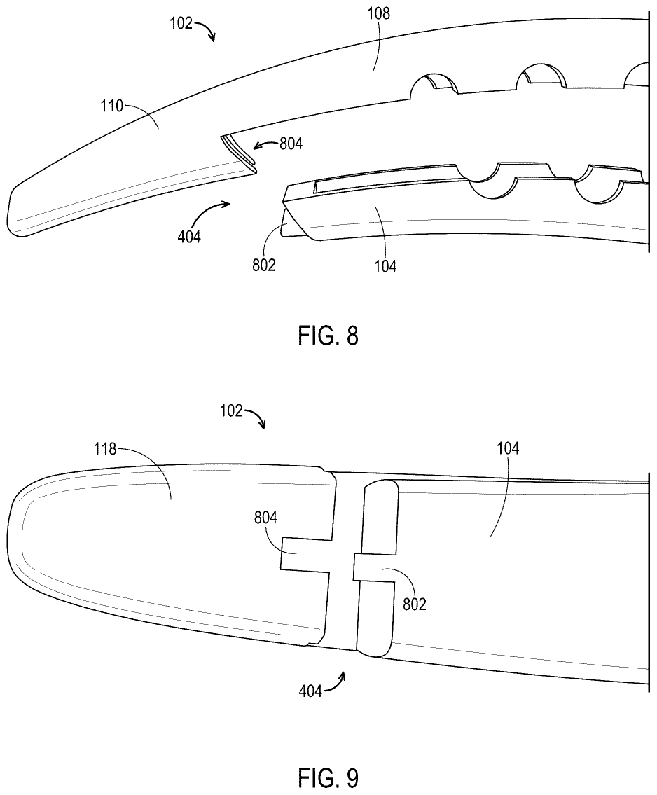

FIG. 8 is an exploded side view of the locking system 404. FIG. 9 is an exploded top view of the locking system 404. The example locking system 404 includes a small outwardly protruding locking tab 802 disposed on the distal end of the belly portion 104. The locking system 404 further includes a locking tab receiving cavity 804 disposed at the proximal end of the tail portion 110. After the hinge tab 702 and the hinge cavity 602 are engaged, and the distal end of the belly portion 104 is rotatably urged towards the proximal end of the tail portion, the locking tab receiving cavity 804 is configured to engage and releasably receive the locking tab 802 so that the belly portion 104 is releasably secured to the body portion 102. In a preferred embodiment, wherein as the locking tab 802 is urged towards the locking tab receiving cavity 804, the midsection portion 108 of the body portion 102 is flexed so that the locking tab 802 has sufficient clearance from the proximal end of the tail portion 108 of the body portion 102 so that the locking tab may 802 enter into the locking tab receiving cavity 804. When the belly portion 104 is secured to the body portion 102, the locking tab 802 is inside of the locking tab receiving cavity 804. Here, the locking tab 802 cannot escape from the locking tab receiving cavity 804.

When the midsection portion 108 is flexed (see FIGS. 4 and 5) to release the belly portion 104 from the body portion 102, the distal end of the body portion 102 is pulled backwardly so that the locking tab 802 may escape the locking tab receiving cavity 804. In a preferred embodiment, the locking tab 802 is released from the locking tab receiving cavity 804 when the midsection portion 108 of the body portion 102 is flexed so that the locking tab 802 has sufficient clearance from the proximal end of the tail portion 110 of the body portion 102 so that the locking tab 802 may be released from into the locking tab receiving cavity 702. After release of the locking tab 802 from the locking tab receiving cavity 804, the belly portion 102 may be rotatably urged about the hinge system to separate the body portion 102 from the belly portion 104 to provide access to the bait retaining cavity xxx.

When the belly portion 104 is later secured with the body portion 102, the user presses the distal end on the belly portion 104 towards the body portion 102. The exerted force urges the locking tab 802 into the locking tab receiving cavity 804 such that the locking tab 802 is pushed back into the locking tab receiving cavity 804.

Alternative embodiments of the fish bait retaining lure 100 may use alternative locking systems 404 to releasably secure the distal end of the belly portion 104 to the proximal end of the tail portion 110. All such alternative embodiments are intended to be included within this disclosure of the invention and to be protected by any accompanying claims.

The preferred embodiment illustrated in FIGS. 1-9 have the hinge system 402 located at the junction of the distal end of the nose portion 106 and the proximal end of the belly portion 104. The locking system 404 is located at the junction of the distal end of the belly portion 104 and the proximal end of the tail portion 110. In other embodiments, the locking system 404 is located at the junction of the distal end of the nose portion 106 and the proximal end of the belly portion 104, and the hinge system 402 is located at the junction of the distal end of the belly portion 104 and the proximal end of the tail portion 110.

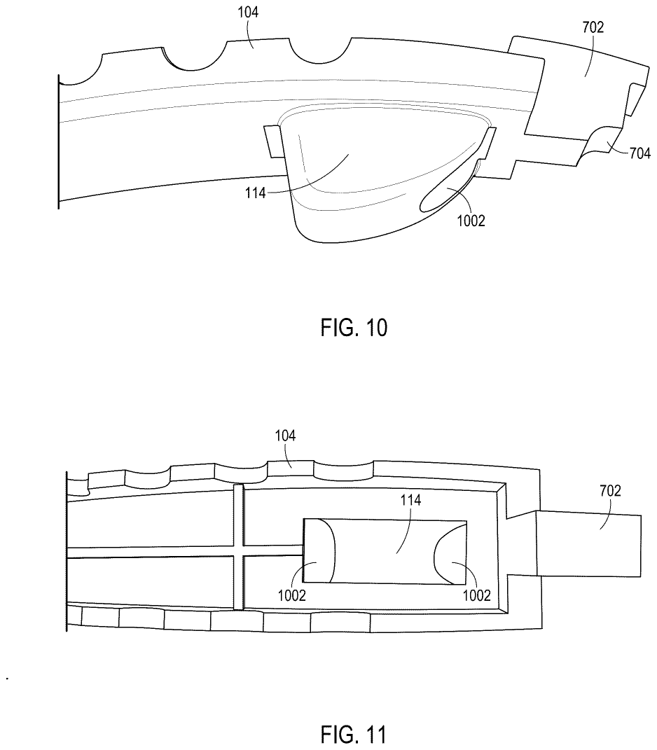

FIG. 10 is a side perspective view of the hook garage 114 disposed near the proximal end of the belly portion 104. The hook garage 114 extends outwardly from a bottom of the belly portion 104 proximate to the proximal end of the belly portion 104. The hook garage 104 is a hollow structure with a first aperture 1002 at the proximal end of the hook garage 104 and a second aperture 1002 at the distal end of the hook garage 104.

FIG. 11 is a bottom view of the proximal end of the belly portion 104 showing the interior passage of the hook garage 114. As shown in FIG. 2, a fishing line 40 is thread through apertures 1002 of the interior passage of the hook garage 114 so that the fish bait retaining lure 100 freely rotates around the fishing line 40 when in use. The aperture of the hook garage 114 is at least substantially aligned along the axis 118 (FIG. 2) of the fishing line tunnel 116.

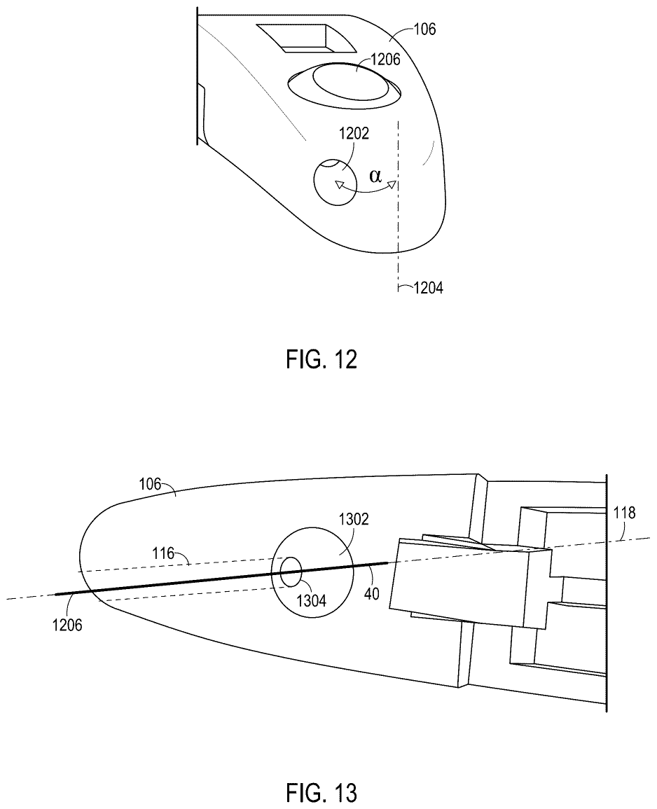

FIG. 12 is a frontal view of the nose portion 106 of the body portion 102. A front (first) aperture 1202 at the proximal end of the fishing line tunnel 116 is shown offset from the centerline 1204 of the body portion 102 by a predefined angle α. The offset facilitates rotational movement of the fish bait retaining lure 100 during use. An example embodiment employs an angle α of between 10° and 20°, though any suitable magnitude of the angle a may be used. The angle α may be defined based on an anticipated target game fish, an anticipated depth of use, and/or an anticipated speed of use so as to optimize the effectiveness of the fish bait retaining lure 100.

The diameter of the fishing line tunnel 116 is preferably greater than the diameter of the fishing line 40 (FIG. 2) that is used to rig the fish bait retaining lure 100 with one or more hooks 20. The larger diameter of the fishing line tunnel 116 facilitates rotation of the fish bait retaining lure 100 about the fishing line 40, thereby reducing friction and undesirable twisting of the fishing line 40 during use. In an example embodiment, the diameter of the fishing line tunnel 116 is two time the diameter of the fishing line 40.

As noted herein, embodiments of the fish bait retaining lure 100 may be decorated with any color and/or pattern of interest. In some embodiments, a small colored half bead 1206, interchangeably referred to herein as an eye piece 1206. The eye piece 1206 emulates the eye of a bait fish. The eye piece 1208 may be added to the top of and/or the bottom of the nose portion 106 to make the fish bait retaining lure 100 more attractive to game fish. Any suitable decoration may be added to the fish bait retaining lure 100.

FIG. 13 is a bottom view of the nose portion 106. An optional cup-like indentation 1302, interchangeably referred to herein as a fishing line cup aperture 1302, is formed proximate to a distal end of the now portion 106 and on the bottom surface of the nose portion 106. A second aperture 1304 of the fishing line tunnel 116 is disposed at a distal end of the fishing line tunnel 116 and along a side wall of the cup-like indentation 1302. Use of the cup-like indentation 1302 that has the aperture 1304 of the fishing line tunnel 116 provides several unexpected benefits.

First, the wall of the cup-like indentation 1302 proximate to and surrounding the aperture 1304 provides a greater strength and resiliency to the material of the nose portion 106. As the fish bait retaining lure 100 rotates during use, wear induced by the fishing line on the fish bait retaining lure 100 is reduced since the orientation of the axis 118 of the fishing line tunnel 116 and the fishing line 40 are substantially the same. Also, the plane of outer surface of the aperture 1304 is substantially aligned perpendicular with the axis 118 of the line tunnel 116. Accordingly, potentially damaging frictional contact with the edges of the aperture 1304 with the fishing line 40 is reduced. Similarly, potential damage to the fishing line 40 caused by rotation of the fish bait retaining lure 100 during use is reduced.

Additionally, a cup-like shape of the cup shape of the indentation 1302 facilitates rigging of the fish bait retaining lure 100. One skilled in the art appreciates that threading the fishing line 40 through a small hole can be difficult, especially when the user is in the field under cold weather conditions, storm conditions, and/or low light levels. With embodiments of the fish bait retaining lure 100 having the cup-like indentation 1302, the user simply urges the end of the fishing line 40 into the cup-like indentation 1302. The shape of the cup-like indentation 1302 helps guide the end of the fishing line 40 into the aperture 1304 and then into the fishing line tunnel 116. In some instances, the user may even be able to thread the fishing line 40 into the fishing line tunnel 116 while their hands are wearing hand gloves.

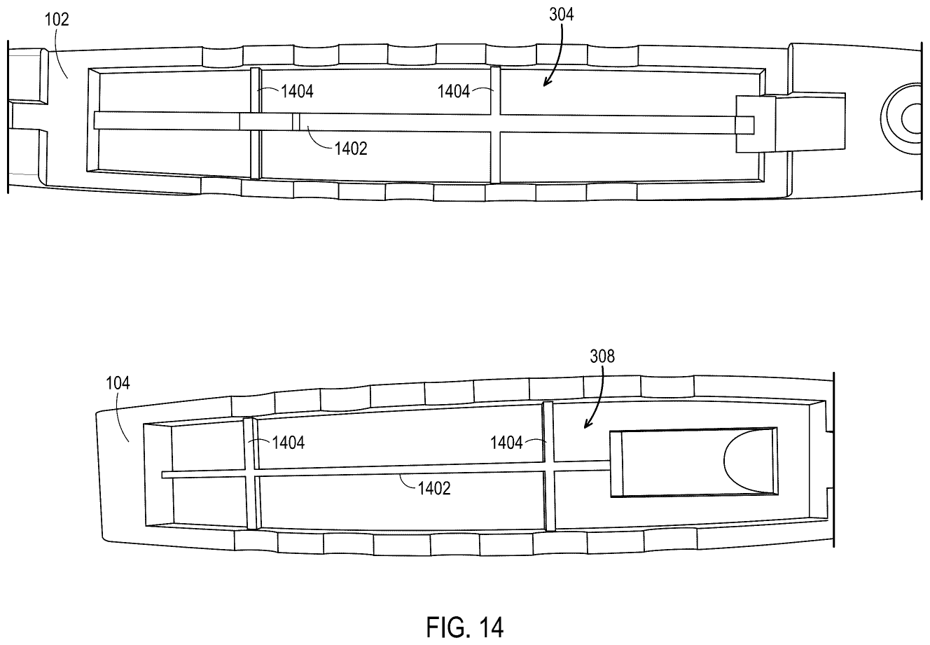

FIG. 14 is a view of the cavity 304 of the body portion 102 and the cavity 308 of the belly portion 104. In preferred embodiments, a lateral rib 1402 is disposed within the body portion 102 and/or the belly portion 104. The thickness and height of the lateral rib 1402 is configured to control the degree of flexibility and to provide structural integrity and strength to the body portion 102 and/or the belly portion 104. Here, a predefined flexibility coefficient may be used to specify the degree of flexibility for the various portions of the body portion 102 and/or the belly portion 104. Any suitable number of lateral ribs 1402 located at any selected location may be used in alternative embodiments.

In preferred embodiments, two cross ribs 1404 are disposed within the body portion 102 and/or the belly portion 104. The cross rib 1404 is oriented perpendicular to the lateral rib 1402 in the example embodiment. The thickness and height of the cross rib 1404 is configured to control with degree of flexibility and to provide structural integrity and strength to the body portion 102 and/or the belly portion 104. The ribs 1402, 1403 bending and flexing of the body portion 102 and/or the belly portion 104 without breakage. Any suitable number of cross ribs 1404 and/or lateral ribs may be located at any selected location in alternative embodiments.

During fabrication of a preferred embodiment, the body portion 102 and the belly portion 104 are preferably made of a selected moldable material that is injected into a mold. After hardening, the solid nose portion 106 and solid tail portion 110 are rigid or substantially rigid. The midsection portion 108 of the body portion 102 is flexible or semi-flexible. Optionally, the belly portion 104 may also be flexible. Alternative embodiments may be fabricated in different matters.

While the preferred embodiment of the invention has been illustrated and described, as noted above, many changes can be made without departing from the spirit and scope of the invention. Each disclosure of a component preferably having a feature or characteristic is intended to also disclose the component as being devoid of that feature or characteristic, unless the principles of the invention clearly dictate otherwise. Accordingly, the scope of the invention is not limited by the disclosure of the preferred embodiment. Instead, the invention should be determined entirely by reference to the claims that follow. It should also be noted that the claim dependencies or combinations of elements recited in the claims does not reflect an intention to forgo claiming other subject matter disclosed herein. Instead, this disclosure is intended to also disclose the subject matter of any combination of any two or more of the claims, such that subsequent claim sets may recite that any one of the dependent claims depends from any other one or more claims, up to and including all other claims in the alternative (such as “The apparatus or method of any one of the preceding or subsequent claims . . . ”). This disclosure is also intended to disclose the subject matter of any one of the dependent claims, as if it was an independent claim, with or without all or a portion of the subject matter of the original independent claim(s) or any other subject matter disclosed herein.

1. A fish bait retaining lure comprising:
a belly portion; and
a body portion, wherein the body portion comprises:
a nose portion;
a midsection portion that is flexible, wherein a flexibility of the midsection portion corresponds to a predefined flexibility coefficient; and
a tail portion,
wherein the body portion and the belly portion cooperatively define a bait retaining cavity in the fish bait retaining lure that is configured to releasably hold a bait material of interest.

2. The fish bait retaining lure of claim 1, wherein the predefined flexibility coefficient is selected to define a predefined degree of flexibility of the midsection portion of the body portion.

3. The fish bait retaining lure of claim 1, further comprising:
a hinge system,
wherein a first part of the hinge system is defined by a hinge tab disposed on and outwardly protruding from a proximal end of the belly portion,
wherein a second part of the hinge system is defined by a hinge cavity disposed at a distal end of the nose portion of the body portion, and
wherein the hinge cavity is configured to releasably receive and retain the hinge tab so that the belly portion is securable to the body portion.

4. The fish bait retaining lure of claim 3, wherein the hinge system is a hinge cam.

5. The fish bait retaining lure of claim 3, further comprising:
a locking system,
wherein a first part of the locking system is defined by a locking tab disposed on and outwardly protruding from a distal end of the belly portion,
wherein a second part of the locking system is defined by a locking tab receiving cavity disposed at a proximal end of the tail portion of the body portion,
wherein after the hinge tab rotatable engages the hinge cavity, the distal end of the belly portion is rotatably urged towards the proximal end of the tail portion, and
wherein the locking tab is urged into locking tab receiving cavity to engage and releasably receive the locking tab so that the belly portion is releasably secured to the body portion.

6. The fish bait retaining lure of claim 5, wherein as the locking tab is urged into the locking tab receiving cavity, the midsection portion of the body portion is flexed so that the locking tab has sufficient clearance from the proximal end of the tail portion of the body portion so that the locking tab may enter into the locking tab receiving cavity.

7. The fish bait retaining lure of claim 6,
wherein the locking tab is released from the locking tab receiving cavity when the midsection portion of the body portion is flexed so that the locking tab has sufficient clearance from the proximal end of the tail portion of the body portion so that the locking tab may be released from the locking tab receiving cavity, and
wherein after release of the locking tab from the locking tab receiving cavity, the belly portion may be rotatably urged about the hinge system to separate the body portion from the belly portion to provide access to the bait retaining cavity.

8. The fish bait retaining lure of claim 7, wherein after the locking tab is released from the locking tab receiving cavity, the hinge tab is separable from the hinge cavity so that the belly potion is separable from the body portion.

9. The fish bait retaining lure of claim 1, further comprising:
a fishing line cup aperture disposed proximate to the distal end of the nose portion and on a bottom surface of the nose portion; and
a fishing line tunnel disposed through the nose portion that is configured to receive a fishing line,
wherein a first aperture of the fishing line tunnel is at the proximal end of the nose portion, and
wherein a second aperture of the fishing line tunnel is disposed in the fishing line cup aperture.

10. The fish bait retaining lure of claim 9, wherein the fishing line cup aperture is defined by a cup-like indentation, and wherein the second aperture of the fishing line tunnel is disposed along a side wall of the fishing line cup aperture.

11. The fish bait retaining lure of claim 10, wherein a cup-like shape of the fishing line cup aperture is configured to guide the fishing line into the second aperture of the fishing line tunnel.

12. The fish bait retaining lure of claim 11, wherein a diameter of the fishing line tunnel is greater than a diameter of the fishing line so that the fish bait retaining lure rotates about the fishing line during use.

13. The fish bait retaining lure of claim 11, wherein the fishing line tunnel is offset from a centerline of the body portion by a predefined angle a, wherein the offset facilitates rotational movement of the fish bait retaining lure about the fishing line during use.

14. The fish bait retaining lure of claim 13, further comprising:
a hook garage extending outwardly from a bottom of the belly portion proximate to the proximal end of the belly portion,
wherein the hook garage is a hollow structure with a first aperture at the proximal end of the hook garage and a second aperture at the distal end of the hook garage,
wherein the fishing line is initially thread into the second aperture of the hook garage, through the hollow structure of the hook garage, and out of the first aperture of the hook garage before the fishing line is guided into the fishing line tunnel at the fishing line cup aperture, and
wherein during use, the fish bait retaining lure freely rotates about the fishing line that extends through the fishing line tunnel and the hook garage.

15. The fish bait retaining lure of claim 1,
wherein the body portion is defined by a first body portion side wall and a second body portion side wall that cooperatively define a body cavity,
wherein the belly portion is defined by a first belly portion side wall and a second belly portion side wall that cooperatively define a belly cavity, and
wherein when the belly portion is secured to the body portion, the body cavity and the belly cavity cooperatively define the bait retaining cavity.

16. The fish bait retaining lure of claim 15,
wherein the first body portion side wall is defined by a first edge surface and the second body portion side wall is defined by a second edge surface,
wherein the first belly portion side wall is defined by a third edge surface and the second belly portion side wall is defined by a fourth edge surface, and
wherein when the belly portion is secured to the body portion, the first edge surface engages the corresponding third edge surface, and the second edge surface engages the corresponding fourth edge surface so that the engaged edge surfaces retain bait within the bait retaining cavity.

17. The fish bait retaining lure of claim 16,
wherein the engaged first edge surface and the corresponding third edge surface emulate a first lateral line of a baitfish,
wherein the engaged second edge surface and the corresponding fourth edge surface emulate a second lateral line of a baitfish, and
wherein the first lateral line and the second lateral line are on opposing sides of the fish bait retaining lure.

18. The fish bait retaining lure of claim 17,
wherein the engaged first edge surface and the corresponding third edge surface include at least one first aperture along the first lateral line, and
wherein the engaged second edge surface and the corresponding fourth edge surface include at least one second aperture along the first lateral line.

19. The fish bait retaining lure of claim 18,
wherein the at least one first aperture is one of a plurality of first apertures aligned along the first lateral line, and
wherein the at least one second aperture is one of a plurality of second apertures aligned along the second lateral line.

20. The fish bait retaining lure of claim 1,
wherein the bait retaining lure is a first bait retaining lure having an exterior surface defined by a first color and a first pattern,
wherein a second bait retaining lure an exterior surface defined by a second color and a second pattern, and
wherein response to securing the belly portion of the second bait retaining lure to the body portion of the first bait retaining lure, the bait retaining lure has an exterior surface defined by the first color, the second color, the first pattern, and the second pattern.
